(19) United States
(12) Patent Application Publication
(10) Pub. No.: US 2007/0297338 A1
(43) Pub. Date: Dec. 27, 2007

(54) Verification of path selection protocol in a multi-path storage area network

(76) Inventors: Yun Mou, Tucson, AZ (US); Khank Vi Ngo, Tucson, AZ (US); Noah Jonathan Sellars, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/473,929

(22) Filed: Jun. 23, 2006

(51) Int. Cl. H04J 3/14

(52) U.S. Cl. 370/242

(57) ABSTRACT

For a storage area network, verification of path selection protocol comprises disabling a switch port on a switch of the primary path of a data storage device; initiating an input/output command to the device; verifying that a failover occurred. The switch port for the primary path is enabled, an “immediate” input/output command is initiated to the device with the “immediate” bit set; and, in response to a notification by the device resulting from the “immediate” bit, a switch port is disabled on the switch of the primary path for the device; and the method verifies that a failover occurred.

### FIELD OF THE INVENTION

This invention relates to multi-path storage area networks, and, more particularly, to storage area networks having alternate pathing capability.

### BACKGROUND OF THE INVENTION

Multi-path storage area networks typically allow a host system or host systems to communicate with data storage devices, such as data storage subsystems, automated data storage libraries, and data storage drives. Storage area networks (called “SAN” including the data storage devices, and the communication components called “SAN fabric”) comprise links of fiber optic cabling and comprise switches to direct the signals. The SAN fabric may be cascaded or non-cascaded. Cascaded means more than one switch of a particular family are connected together via inter switch links. The switches and directors have multiple switch ports where the fiber optic cables are attached, and have command links accessible by the host system, e.g., via Ethernet. The host systems may configure the switches and data storage devices to provide paths for the signals, and may also group certain ports in the configuration to provide alternate pathing for the signals.

One purpose of alternate pathing in a multi-path storage area network is to provide availability of the network despite failure or errors of one or more of the links.

Typically, when a device driver configures a logical device with alternate pathing support enabled, the first logical device configured becomes the primary path. When a second logical device is configured with alternate pathing support enabled for the same physical device, it configures as an alternate path. A third logical device may also be configured as an alternate path, etc. For example, a device driver supports up to 16 physical paths for a single device.

Thus, if the primary path fails, an alternate or backup path is available for continued communication.

### SUMMARY OF THE INVENTION

Storage area networks, computer program products and methods for verifying path selection protocol in a multi-path switched network. An embodiment of a method comprises disabling a switch port on a switch of primary path of a data storage device; initiating an input/output command to the data storage device; and verifying that a failover occurred. The switch port for the primary path is enabled, and an “immediate” input/output command is initiated to the device with the “immediate” bit set. In response to a notification by the data storage device resulting from the “immediate” bit, the method comprises disabling a switch port on the switch of primary path of the data storage device; and verifying that a failover occurred.

In a further embodiment of the invention, the step of enabling the switch port on the switch of primary path additionally comprises the steps of disabling a switch port on a switch of alternate path; initiating an input/output command to the data storage device; and verifying that failover occurred.

In a still further embodiment of the invention, the method additionally comprises the steps of, subsequent to verifying that a failover occurred with respect to the “immediate” input/output command to the alternate path, initiating an “immediate” input/output command to the data storage drive with the “immediate” bit set; in response to a notification by the device resulting from the “immediate” bit on the alternate path, the primary switch port on the switch of primary path is enabled and a switch port on the switch of alternate path of the data storage device is disabled; and the method comprises verifying that a failover occurred.

For a fuller understanding of the present invention, reference should be made to the following detailed description taken in conjunction with the accompanying drawings.

### BRIEF DESCRIPTION OF THE DRAWINGS

FIG. 1 is a block diagram of a storage area network(s) that may implement embodiments of the present invention; and

FIG. 2 is a flow chart depicting embodiments of computer processor implemented methods in accordance with the present invention for the storage area network(s) of FIG. 1.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

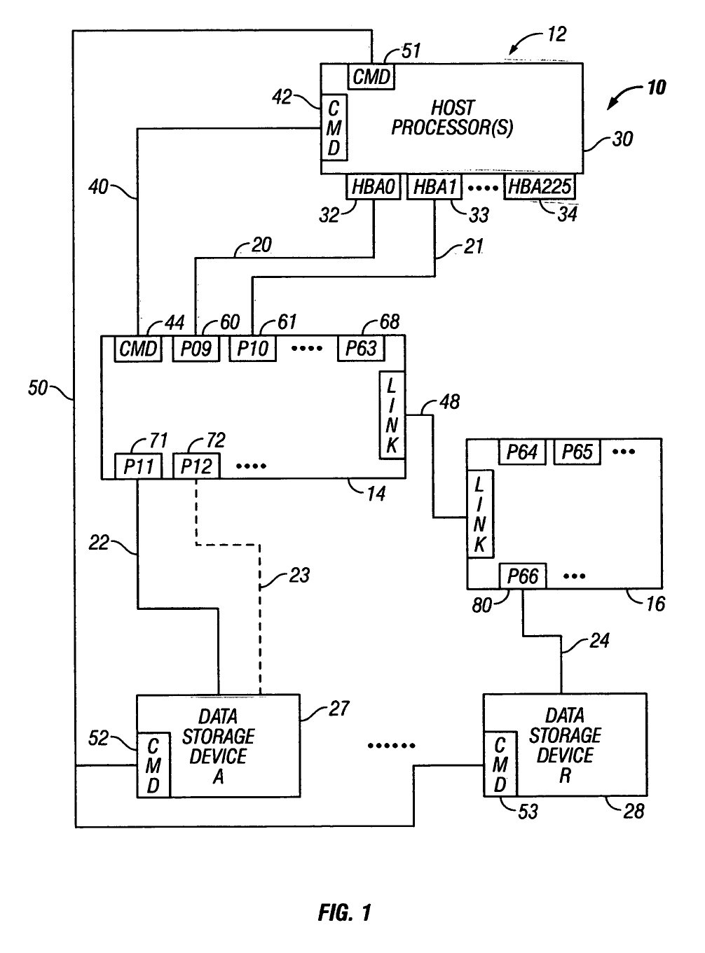

Referring to FIG. 1, a simplified multi-path storage area network 10 is illustrated comprising a host system 12, at least one switch 14, 16, and a plurality of path links 20, 21, 22, 23 and 24 for providing communication for a plurality of data storage devices 27, 28. The host system may comprise at least one host processor 30, and a plurality of host bus adapters 32, 33, 34. As is known to those of skill in the art, the host system may comprise a storage server, a network host, etc., and the host processor(s) are operable by operating system(s) and computer program products tangibly embodied on at least one computer readable medium, configured to be usable with at least one programmable computer processor. The computer program products may be stored in memory, magnetic media, optical media, and/or electronic media, etc., and may be supplied over a network, by magnetic media, optical media, and/or electronic media, etc.

The path links 20, 21, 22, 23 and 24 may comprise optical links such as fiber optic cabling, one example comprising Fibre optic cabling and connectors and may extend locally and/or remotely with respect to the host system 12. The switches 14, 16 may comprise any of various types of optical switches, such as IBM® TotalStorage SAN Switch M12, IBM® TotalStorage SAN Switch F16, IBM® TotalStorage SAN24M-1, etc. Switches may also be called “directors”. The switches are controlled by the host system, for example, over an Ethernet command link 40 between at least one command port 42 of the host system 12 and at least one command port 44 of the switch(es). Command link(s) 50, 51, 52, 53 may be provided to configure and operate the data storage devices 27, 28. The SAN fabric may be cascaded or non-cascaded. Cascaded means more than one switch of a particular family are connected together via inter switch links. The example of FIG. 1 comprises a cascaded SAN fabric with switches 14 and 16 interconnected via inter switch links 48. The example of FIG. 1 becomes non-cascaded by the elimination of the switch 16 and links 48. The ports 60, 61 . . . 68 and ports 71, 72 . . . 80 which comprise links to the host system may be configured as HBA (Host Bus Adapter) ports.

The data storage devices 27, 28, etc., may comprise an automated data storage library, a magnetic tape drive, etc. The host system 12 may configure the switches 14, 16 and the device drivers of the data storage devices 27, 28, and establishes the primary and alternate paths, as is known to those of skill in the art. For example, when the device driver configures a logical device with alternating pathing enabled, the first logical device configured becomes the primary path. Labels may be appended to the location fields of the logical devices to indicate the primary and alternate paths. For example, -PRI may be appended to the location field of a Fibre attached logical device to designate the primary path, and -ALT appended to the location field of a logical device to designate an alternate path. Thus, in one example where the device driver supports up to 16 physical paths for a single device, if an “smc0” is configured first, then an “smc1”, and an “smc2”, the command location field may appear as “smc0 Available 20-60-01-PRI IBM Library (FCP)”, “smc1 Available 30-68-01-ALT IBM Library (FCP)”, “smc2 Available 30-68-01-ALT IBM Library (FCP)”. In the illustrated example, the primary path for data storage device 27 may comprise a logical device using ports 60 and 71, which are switched by switch 14 to provide the signals across links 20 and 22, and an alternate path for data storage device 27 may comprise a logical device using ports 60 and 72, which are switched by switch 14 to provide the signals across links 20 and 23. Alternatively, the primary path for data storage device 27 may comprise ports 60 and 71, and links 20 and 22, and the alternate path for data storage device 27 may comprise ports 61 and 72, which are switched by switch 14 to provide the signals across links 21 and 23. The primary and alternate paths may be considered to be “zoned” together, for example, by worldwide node name, as is known to those of skill in the art. The data storage device may be configured to supply any reply to the host over both the primary and alternate paths. An example of a primary path is illustrated for the host system 12 and data storage device 28, comprising ports 61 and 80, together with inter switch links 48, which are switched by switches 14, 16 to provide the signals across links 21 and 24. Data storage device 28 and the remainder of data storage devices (illustrated by dots) may be provided with both a primary path and with at least one alternate path. Switching between the primary paths and alternate paths is typically conducted by the host system 12, via the command links 40, 42, 44, using a path selection protocol. Thus, should a path become unavailable, the path selection protocol is activated and the host system operates the switches, e.g. switches 14, 16, to provide the signals over an alternate path.

The present invention allows for verification of path selection protocol without manual intervention by the user, for example, by unplugging cables.

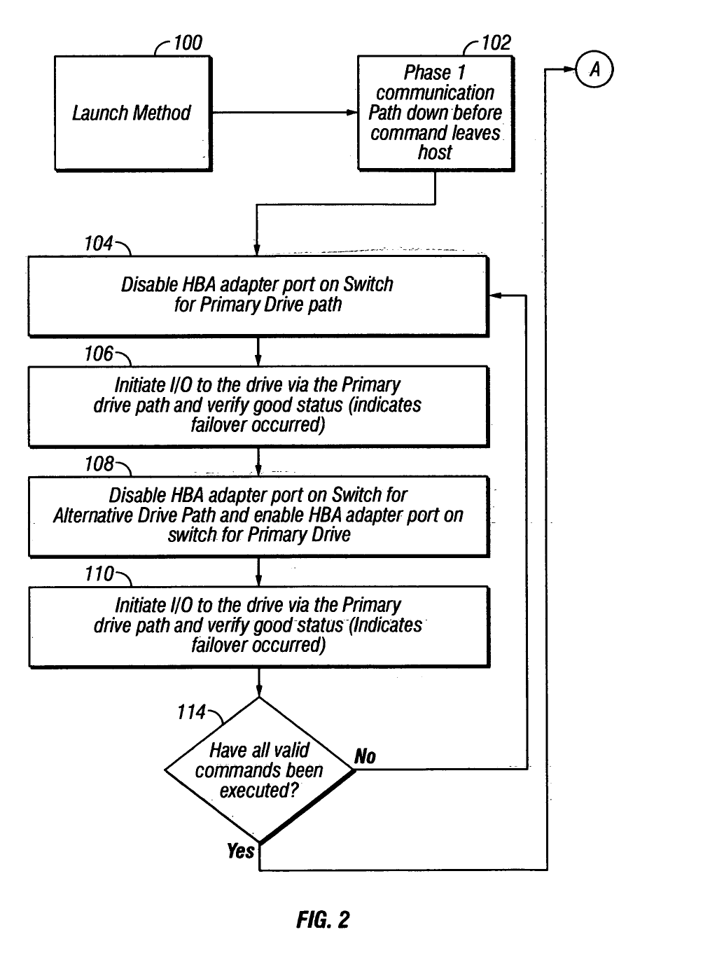

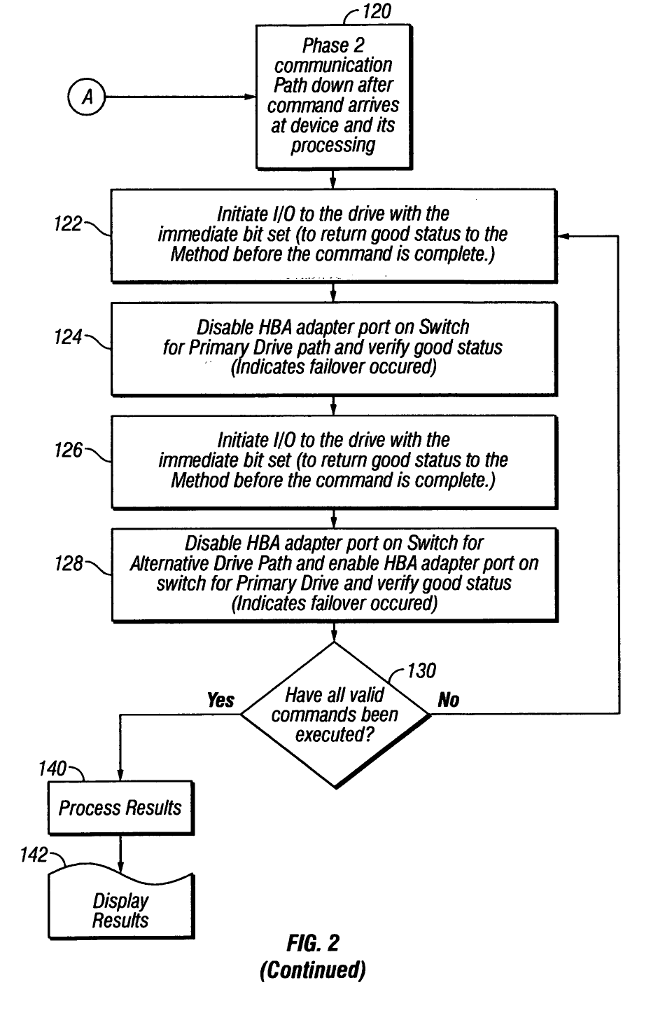

Embodiments of a method are illustrated in FIG. 2, which comprises a computer implemented method, for example, implemented by host processor(s) 30 of FIG. 1, in accordance with one or more computer program products. Referring to FIGS. 1 and 2, the method is launched in step 100, and comprises, in phase 1 initiated at step 102, disabling a switch port on a switch of primary path of a data storage device before a command for the data storage device whose paths are being tested leaves the host system. For the purpose of illustration, the path selection protocol for data storage device 27 will be tested, comprising primary path of ports 60 and 71, which are switched by switch 14 to provide the signals across links 20 and 22, and an alternate path comprising ports 60 and 72, which are switched by switch 14 to provide the signals across links 20 and 23. Thus, in step 104 the host system 12, via command link 40, 42, 44, operates the switch 14 to turn off port 71 to thereby disable the HBA adapter port for the primary path to the data storage device 27, which may be a data storage drive.

In step 106, the host system 12 initiates an input/output command to the data storage device; and verifying that a failover occurred. In the example, receipt of the command over the alternate path, comprising ports 60 and 72, which, in the failover are switched by switch 14 to provide the signals across links 20 and 23, is shown as being verified by “good status”. The data storage device may provide the “good status” verification at both the primary and alternate paths, but is received over the alternate path.

In step 108, the host system 12 enables the switch port for the primary path, e.g. port 71, and disables the alternate path port 72. In step 110, the host system initiates another input/output command to the data storage device; and verifies that a failover occurred from the alternate path. In the example, receipt of the command over the primary path, comprising ports 60 and 71, which, in the failover are switched by switch 14 to provide the signals across links 20 and 22, is shown as being verified by “good status”. Step 114 determines whether all valid commands have been executed, and, if so, the method proceeds to phase 2, initiated at step 120.

In accordance with the present invention, phase 2 comprises initiating an “immediate” input/output command to the device with the “immediate” bit set. In response to a notification by the data storage device resulting from the “immediate” bit, the method comprises disabling a switch port on the switch of primary path of the data storage device; and verifying that a failover occurred. In step 122, with the primary path enabled, the host system 12 initiates an “immediate” input/output command to the data storage device 27 with the “immediate” bit set. As is known to those of skill in the art, an “immediate” bit is part of a Fibre attached I/O control command, and when the “immediate” bit is set, it means that the target device will respond to the initiator that it received the command prior to the target device completing the command. In accordance with the present invention, this is how the host system will be able to determine if the command has arrived at the target device. In the example, in step 122, the data storage device 27 returns “good status” to the host system 12 over the primary path before the command has been completed.

In response to a notification by the data storage device resulting from the “immediate” bit, in the example “good status”, the method comprises disabling a switch port on the switch of primary path of the data storage device; and verifying that a failover occurred, in step 124. In the example, the host system 12, via command link 40, 42, 44, operates the switch 14 to turn off port 71 to thereby disable the HBA adapter port for the primary path to the data storage device 27.

In step 124, the data storage device, having notified that the command was received in step 122, completes the command over the alternate path. As above, the data storage device may notify the completion at both the primary and alternate paths. In the example, the host system, in accordance with the path selection protocol, provides the failover by causing switch 14 to switch to the alternate path and provide the signals across links 20 and 23, comprising ports 60 and 72, and the data storage device 27 completes the command and the failover is shown as being verified by “good status”.

In step 126, the path selection protocol of switching from an alternate path back to the primary path is tested. In accordance with an embodiment of the invention, the method additionally comprises, subsequent to verifying that a failover occurred with respect to the “immediate” input/output command to the alternate path, the host system 12 initiates another “immediate” input/output command to the data storage drive 27 with the “immediate” bit set. In the example, in step 126, the data storage device 27 returns “good status” to the host system 12 over the alternate path before the command has been completed.

In step 128, in response to a notification by the device resulting from the “immediate” bit, the primary switch port on the switch of primary path is enabled and a switch port on the switch of alternate path of the data storage device is disabled; and the method comprises verifying that a new failover occurred. In the example, the host system, in accordance with the path selection protocol, provides the failover by causing switch 14 to switch back to the primary path and provide the signals across links 20 and 22, comprising ports 60 and 71, and the data storage device 27 completes the command and the failover is shown as being verified by “good status”.

Step 130 determines whether all valid commands have been executed, and, if so, the method proceeds to steps 140 and 142 to process and display the results.

Those of skill in the art will understand that changes may be made with respect to the arrangement of the steps of FIG. 2, either or both omitting some of the steps not requiring some of the steps not requiring an “immediate” command and changing the ordering of some of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. Method for verification of path selection protocol in a multi-path switched storage area network, comprising the steps of:
disabling a switch port on a switch of primary path of a data storage device;
initiating an input/output command to said data storage device;
verifying that a failover occurred;
enabling said switch port on said switch of primary path;
initiating an “immediate” input/output command to said data storage drive with the “immediate” bit set;
in response to a notification by said data storage device resulting from said “immediate” bit, disabling a switch port on said switch of primary path of said data storage device; and
verifying that a failover occurred.

2. The method of claim 1, wherein said step of enabling said switch port on said switch of primary path additionally comprises the steps of:
disabling a switch port on a switch of alternate path;
initiating an input/output command to said data storage device; and
verifying that failover occurred.

3. The method of claim 2, additionally comprising the steps of:
subsequent to verifying that a failover occurred with respect to said “immediate” input/output command, initiating an “immediate” input/output command to said data storage drive with the “immediate” bit set;
in response to a notification by said data storage device resulting from said “immediate” bit, enabling said switch port on said switch of primary path, and disabling a switch port on said switch of alternate path of said data storage device; and
verifying that a failover occurred.

4. A storage area network configured to provide communication with a plurality of data storage devices, comprising:
a plurality of switches and links, said switches having a plurality of switch ports coupling to said links and arranged to define at least a primary path and at least one alternate path to at least one of said data storage devices; and
a host system having at least one command link to at least one of said switches of said primary path and said alternate path; said host system performing operations comprising the steps of:
disabling a switch port on a switch of said primary path of a data storage device;
initiating an input/output command to said data storage device;
verifying that a failover occurred;
enabling said switch port on said switch of primary path;
initiating an “immediate” input/output command to said data storage drive with the “immediate” bit set;
in response to a notification by said data storage device resulting from said “immediate” bit, disabling a switch port on said switch of said primary path of said data storage device; and
verifying that a failover occurred.

5. The storage area network of claim 4, wherein said host system step of enabling said switch port on said switch of primary path additionally comprises the steps of:
disabling a switch port on a switch of alternate path;
initiating an input/output command to said data storage device; and
verifying that failover occurred.

6. The storage area network of claim 5, wherein said host system additionally performs operations comprising the steps of:
subsequent to verifying that a failover occurred with respect to said “immediate” input/output command, initiating an “immediate” input/output command to said data storage drive with the “immediate” bit set;
in response to a notification by said data storage device resulting from said “immediate” bit, in response to a notification by said data storage device resulting from said “immediate” bit, enabling said switch port on said switch of primary path, and disabling a switch port on said switch of alternate path of said data storage device; and
verifying that a failover occurred.

7. A computer program product tangibly embodied on at least one computer readable medium, configured to be usable with at least one programmable computer processor of a storage area network, comprising:
computer readable program code causing said at least one programmable computer processor to disable a switch port on a switch of primary path of a data storage device;
computer readable program code causing said at least one programmable computer processor to initiate an input/output command to said data storage device;
computer readable program code causing said at least one programmable computer processor to verify that a failover occurred;
computer readable program code causing said at least one programmable computer processor to enable said switch port on said switch of primary path;
computer readable program code causing said at least one programmable computer processor to initiate an “immediate” input/output command to said data storage drive with the “immediate” bit set;
computer readable program code causing said at least one programmable computer processor to, in response to a notification by said data storage device resulting from said “immediate” bit, disable a switch port on said switch of primary path of said data storage device; and
computer readable program code causing said at least one programmable computer processor to verify that a failover occurred.

8. The computer program product of claim 7, wherein said computer readable program code causing said at least one programmable computer processor to enable said switch port on said switch of primary path additionally comprises:
computer readable program code causing said at least one programmable computer processor to disable a switch port on a switch of alternate path;
computer readable program code causing said at least one programmable computer processor to initiate an input/output command to said data storage device; and
computer readable program code causing said at least one programmable computer processor to verify that failover occurred.

9. The computer program product of claim 7, wherein said computer readable program code additionally comprises:
computer readable program code causing said at least one programmable computer processor to, subsequent to verifying that a failover occurred with respect to said “immediate” input/output command, initiate an “immediate” input/output command to said data storage drive with the “immediate” bit set;
computer readable program code causing said at least one programmable computer processor to, in response to a notification by said data storage device resulting from said “immediate” bit, enable said switch port on said switch of primary path, and disable a switch port on said switch of alternate path of said data storage device; and
computer readable program code causing said at least one programmable computer processor to verify that a failover occurred.
